(19) United States
(12) Patent Application Publication
(10) Pub. No.: US 2026/0358188 A1
(43) Pub. Date: Nov. 12, 2026

(54) APPARATUS AND METHOD FOR OPTICAL REFLECTANCE MEASUREMENT

(71) Applicant: Applied Materials, Inc., Santa Clara, CA (US)

(72) Inventors: Benjamin B. RIORDON, Newburyport, MA (US); Jinxin FU, Fremont, CA (US)

(21) Appl. No.: 19/124,024

(22) PCT Filed: Oct. 26, 2023
(86) PCT No.: PCT/US2023/036041

§ 371 Date: Apr. 24, 2025

Related U.S. Application Data
(60) Provisional application No. 63/381,299, filed on Oct. 28, 2022.

(51) Int. Cl. G01M 11/02

(52) U.S. Cl. CPC G01M 11/0207

(57) ABSTRACT

The present disclosure relates to metrology measurement assemblies, and related methods. In one or more embodiments a laser arm assembly includes a laser arm. The laser arm includes a motor mount disposed between a laser end of the laser arm and a second end of the laser arm, the motor mount defining an axis of rotation. The laser arm assembly also includes an optical unit coupled to the laser end of the arm. The optical unit includes a light source, directed towards the axis of rotation. The laser arm assembly also includes a weight disposed on the second end of the arm, and a motor coupled to the motor mount of the arm. The motor includes a brake, a laser motor axis coaxial with the axis of rotation, and an encoder.

### BACKGROUND

### Field

Embodiments of the present disclosure generally relate to optical devices for augmented, virtual, and mixed reality. More specifically, embodiments described herein provide for metrology methods and assemblies.

### Description of the Related Art

Virtual reality is generally considered a computer generated simulated environment in which a user has an apparent physical presence. A virtual reality experience can be generated in 3D and viewed with a head-mounted display (HMD), such as glasses or other wearable display devices that have near-eye display panels as lenses to display a virtual reality environment that replaces an actual environment.

Augmented reality, however, enables an experience in which a user can still see through the display lenses of the glasses or other HMD device to view the surrounding environment, yet also see images of virtual objects that are generated for display and appear as part of the environment. Augmented reality can include any type of input, such as audio and haptic inputs, as well as virtual images, graphics, and video that enhances or augments the environment that the user experiences. As an emerging technology, there are many challenges and design constraints with augmented reality.

One such challenge is measuring optical devices for image quality standards. To ensure that image quality standards are met, metrology metrics of the fabricated optical devices must be obtained. However, existing measurement systems lack a desired field of view and suffer from inaccurate readings and noise. Accordingly, what is needed in the art is a measurement assembly and methods of using the measurement system with improved accuracy and features to decrease noise.

### SUMMARY

The present disclosure relates to metrology measurement assemblies, and related methods. In one or more embodiments a laser arm assembly includes a laser arm. The laser arm includes a motor mount disposed between a laser end of the laser arm and a second end of the laser arm, the motor mount defining an axis of rotation. The laser arm assembly also includes an optical unit coupled to the laser end of the arm. The optical unit includes a light source, directed towards the axis of rotation. The laser arm assembly also includes a weight disposed on the second end of the arm, and a motor coupled to the motor mount of the arm. The motor includes a brake, a laser motor axis coaxial with the axis of rotation, and an encoder.

In one or more embodiments, a measurement assembly includes a laser arm assembly. The laser arm assembly includes a laser arm, a laser motor defining an axis of rotation, and a first optical unit disposed on a laser end of the laser arm. The measurement assembly also includes a reflection arm assembly that includes a reflection arm, a reflection motor, having a motor axis coaxial with the axis of rotation of the laser arm, and a second optical unit disposed on a first end of the reflection arm. The measurement assembly also includes a stage assembly disposed between the laser arm assembly and the reflection arm assembly, the stage assembly includes a pedestal, the pedestal defining a process plane and a movement mechanism, configured to translate the stage assembly.

In one or more embodiments, a measurement assembly includes a laser arm assembly, a reflection arm assembly, a stage assembly, a controller, and a non-transitory computer readable medium. The laser arm assembly includes a laser arm having a laser end, a laser motor, the laser motor defining an axis of rotation, and a first optical unit disposed on the laser end of the laser arm. The reflection arm assembly includes a reflection arm having a first end, a reflection motor comprising a motor axis, the motor axis coaxial with the axis of rotation of the laser arm assembly, and second optical unit disposed on the first end of the reflection arm. The stage assembly is disposed between the laser arm assembly and the reflection arm assembly. The stage assembly includes a pedestal that defines a process plane and a movement mechanism, configured to enable the process plane to be co-planar with the axis of rotation. The controller controls the measurement assembly. The non-transitory computer readable medium includes instructions stored thereon which, when executed by a processor, causes the process to perform a measurement method. The method includes moving a substrate to a first position, rotating the laser arm assembly to align the first optical unit about perpendicular to an orientation angle of a grating on the substrate, rotating the reflection arm assembly to align the second optical unit to about parallel with the orientation angle of the grating, and performing a optical measurement on the grating.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1 is a schematic view of a measurement assembly, according to embodiments described herein.

FIG. 2 is a perspective, schematic view of a measurement assembly according to embodiments described herein.

FIG. 3 is a schematic sectional view of an arm assembly of the measurement assembly in FIG. 2, according to embodiments described herein.

FIG. 4 is a perspective, schematic view of a motor assembly according to embodiments described herein.

FIG. 5 is a flow diagram of a method of optical device metrology according to embodiments described herein.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to optical devices for augmented, virtual, and mixed reality. More specifically, embodiments described herein provide for metrology measurement assemblies and methods. A metrology measurement system and methods are shown and described herein.

The assembly enhances the accuracy of information derived from gratings by features of the measurement assembly described herein. The described embodiments herein allow for accurate localized measurements of individual structures, gratings, and optical device on a surface. The measurements are accomplished though the incorporation of independent arm assemblies, counter weights, and a base that serves as reference for the components and movement mechanisms. The measurement assembly further enables the non-destructive testing. Localized measurements are also in part accomplished by the configuration of the assembly and focus on rigidity of the arm assemblies. For example, in one or more embodiments, arms of the measurement assembly have about the same dimensions to ensure repeatability, accuracy of measurements, and have uniform deflections.

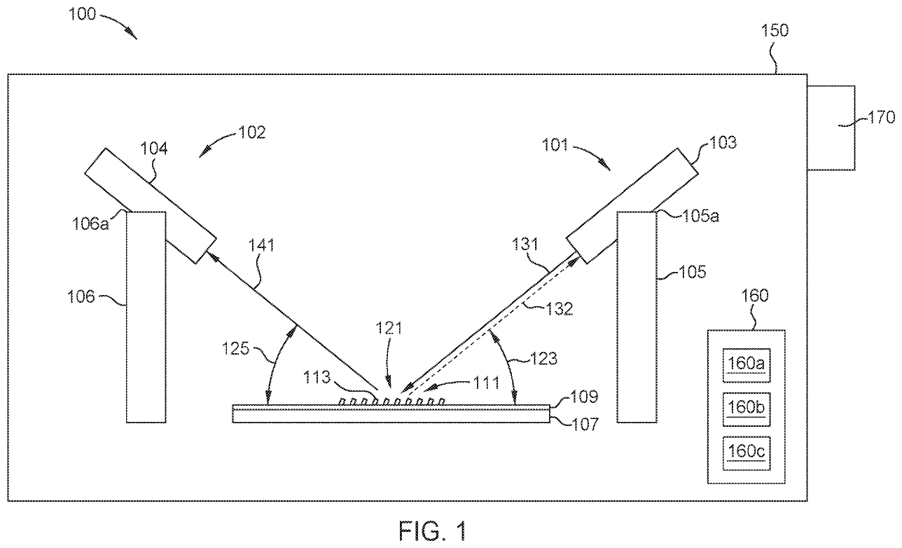

FIG. 1 is a schematic view of a measurement assembly 100, according to embodiments described herein. The measurement assembly 100 includes a laser arm assembly 101 and a reflection arm assembly 102.

The laser arm assembly 101 includes a laser arm 105. The laser arm 105 is a rigid arm. The laser arm 105 maybe a metal arm in some embodiments. The laser arm assembly 101 includes a first optical unit 103, the first optical unit 103 is disposed on a laser end 105a of the laser arm 105. In one or more embodiments the first optical unit 103 is a laser assembly comprising a light source, a lens, a detector, and an aperture. The first optical unit 103 is disposed and coupled to the laser arm 105 so that the first optical unit 103 can be positioned to perform a measurement operation, for example a grating orientation measurement.

The first optical unit 103 directs a first beam 131 to region 121. The first beam 131 is directed at an incidence angle 123. The incidence angle 123 is the angle between the major plane of an optical device 109 and the first beam 131. In one or more embodiments, the first optical unit 103 is a Littrow unit for performing metrology measurements. In one or more embodiments, the first optical unit 103 is a Littrow unit. The Littrow unit is for performing metrology measurements. The first optical unit 103 may include a multi axis position module coupled to an aperture, a light source, and a sensor.

The region 121 includes the optical device 109. The optical device 109 includes one or more gratings 111. The gratings 111 are formed by structures 113. The optical device 109 includes the measuring point of the measurement assembly 100 during a measurement operation. The measurement point may be multiple points on each structure 113, of each grating 111 in each optical device 109. The optical device 109 is disposed over a substrate 107. The structures 113 give the grating 111 a pitch and a grating orientation. In operation, the first beam 131 is project by light source of the first optical unit 103. The first beam 131 is projected towards the optical device 109. The first beam 131 is reflected from the optical device 109. A second beam 132 is reflected back towards the first optical unit 103. A third beam 141 is reflected form the optical device 109 and towards a detector of a second optical unit 104. For example, the first beam 131 strikes a structure 113 of the optical device 109. The striking of the structures 113 is repeated until the optical device 109 imaged by the first optical unit 103 and the second optical unit 104.

The reflection arm assembly 102 includes a reflection arm 106. The reflection arm 106 is a rigid arm. The reflection arm 106 maybe a metal arm in some embodiments. In some embodiments, the reflection arm 106 is about the same as the laser arm 105. In one or more embodiments, the arms 105, 106 are made of a same metal and have the same dimensions. This similarity enhances the repeatability of the measurements. By having the arms 105, 106 have similar mechanical qualities, their respective deflections will also be similar. Therefore, issues caused by mechanical error can be accounted for in a uniform manner instead of having to diagnose errors on a per arm basis. The reflection arm assembly 102 includes a second optical unit 104. The second optical unit 104 is disposed on a first end 106a of the reflection arm 106.

A portion of first beam 131 is reflected towards the second optical unit 104. The portion of the first beam 131 reflected towards the second optical unit 104 is the third beam 141. The second optical unit 104 includes a detector to image the third beam 141. The third beam 141 travels towards the second optical unit 104 at a reflective angle 125. The reflective angle 125 is the angle between the major plane of the optical device 109 and the third beam 141. This is accomplished by having a measuring point of the first optical unit 103 may be about the same as the measuring point of the second optical unit 104. The measuring spot is disposed within the region 121.

The measurement assembly may be disposed in an enclosure 150 according to some embodiments. The enclosure may include an atmospheric control unit 170. The atmospheric control unit 170 may control or monitor one or more of a gas composition within the enclosure 150, a temperature within the enclosure 150, and a moisture level within the enclosure 150. The enclosure 150 and atmospheric control unit 170 enhance the capabilities of the measurement assembly 100 by removing the possibility of contaminants affecting the measurement assembly during operation. The enclosure also enhances safety by preventing potentially harmful light from escaping.

As shown, a controller 160 is in communication with the measurement assembly 100 and is used to control processes and methods, such as at least some of the operations of the methods described herein.

The controller 160 is configured to receive data or input as sensor readings from a plurality of sensors. The sensors can include, sensor in the first optical unit 103, sensors in the second optical unit 104, rotation sensors, encoders, and distance sensors of the measurement assembly 100. The controller 160 is equipped with or in communication with a system model of the measurement assembly 100. The controller 160 is further configured to store readings and calculations. The readings and calculations include previous sensor readings, such as any previous sensor readings within the measurement assembly 100. The readings and calculations further include the stored calculated values from after the sensor readings are measured by the controller 160 and run through the system model. Therefore, the controller 160 is configured to both retrieve stored readings and calculations as well as save readings and calculations for future use. Maintaining previous readings and calculations enables the controller 160 to adjust the system model over time to reflect a more accurate version of the measurement assembly 100.

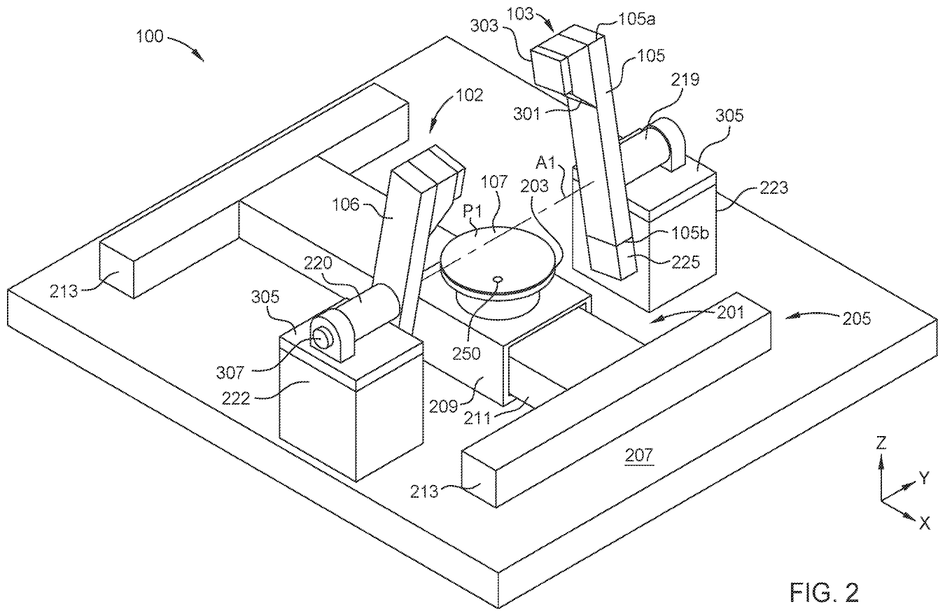

The controller 160 can monitor, estimate an optimized parameter, adjust the angular position of a pedestal 203 (FIG. 2), adjust a pedestal orientation, and/or the height of the pedestal 203, adjust the angular position of the laser arm assembly 101, and adjust the angular position of the reflection arm assembly 102.

The controller 160 includes a central processing unit (CPU) 160a (e.g., a processor), a memory 160b containing instructions, and support circuits 160c for the CPU 160a. The controller 160 controls various items directly, or via other computers and/or controllers. In one or more embodiments, the controller 160 is communicatively coupled to dedicated controllers, and the controller 160 functions as a central controller.

The controller 160 is of any form of a general-purpose computer processor that is used in an industrial setting for controlling various substrate processing chambers and equipment, and sub-processors thereon or therein. The memory 160b, or non-transitory computer readable medium, is one or more of a readily available memory such as random access memory (RAM), dynamic random access memory (DRAM), static RAM (SRAM), and synchronous dynamic RAM (SDRAM (e.g., DDR1, DDR2, DDR3, DDR3L, LPDDR3, DDR4, LPDDR4, and the like)), read only memory (ROM), floppy disk, hard disk, flash drive, or any other form of digital storage, local or remote. The support circuits 160c of the controller 160 are coupled to the CPU 160a for supporting the CPU 160a. The support circuits 160c include cache, power supplies, clock circuits, input/output circuitry and subsystems, and the like.

Operational parameters (e.g., a center-to-edge profile, an angular position of the pedestal 203 and a height of the pedestal 203) and operations are stored in the memory 160b as a software routine that is executed or invoked to turn the controller 160 into a specific purpose controller to control the operations of the various chambers/modules described herein. The controller 160 is configured to conduct any of the operations described herein. The instructions stored on the memory, when executed, cause one or more of operations of a method (such as the method 500 described below) to be conducted in relation to the measurement assembly 100. The controller 160 and the measurement assembly 100 are at least part of a system for measuring using metrology.

The various operations described herein (such as the operations of the method 500) can be conducted automatically using the controller 160, or can be conducted automatically or manually with certain operations conducted by a user.

In one or more embodiments, the controller 160 includes a mass storage device, an input control unit, and a display unit.

The controller 160 is configured to control the sensor devices, the rotational position, the heating, and atmospheric conditions in the enclosure 150 by providing an output to the controls for the atmospheric control unit 170.

The controller 160 is configured to adjust the output to the controls based on the sensor readings, the system model, and the stored readings and calculations. The controller 160 includes embedded software and a compensation algorithm to calibrate measurements.

The one or more machine learning algorithms and/or artificial intelligence algorithms may implement, adjust, and/or refine one or more algorithms, inputs, outputs, or variables described above. Additionally or alternatively, the one or more machine learning algorithms and/or artificial intelligence algorithms may rank or prioritize certain aspects of adjustments of the measurement assembly 100 and/or the method 500 relative to other aspects of the measurement assembly 100 and/or the method 500. The one or more machine learning algorithms and/or artificial intelligence algorithms may account for other changes within the measurement assembly such as hardware replacement and/or degradation.

In one or more embodiments, the one or more machine learning algorithms and/or artificial intelligence algorithms account for upstream or downstream changes that may occur in the measurement assembly due to variable changes of the measurement assembly 100 and/or the method 500. For example, if variable “A” is adjusted to cause a change in aspect “B” of the process, and such an adjustment unintentionally causes a change in aspect “C” of the process, then the one or more machine learning algorithms and/or artificial intelligence algorithms may take such a change of aspect “C” into account. In such an embodiment, the one or more machine learning algorithms and/or artificial intelligence algorithms embody predictive aspects related to implementing the measurement assembly 100 and/or the method 500. The predictive aspects can be utilized to preemptively mitigate unintended changes within a processing system.

The one or more machine learning algorithms and/or artificial intelligence algorithms can use, for example, a regression model (such as a linear regression model) or a clustering technique to estimate optimized parameters. The algorithm can be unsupervised or supervised.

In one or more embodiments, the controller 160 automatically conducts one or more operations described herein without the use of one or more machine learning algorithms or artificial intelligence algorithms.

FIG. 2 is a perspective, schematic view of a measurement assembly according 100 to embodiments described herein. The measurement assembly 100 includes a stage assembly 201. The stage assembly 201 is disposed between the laser arm assembly 101 and the reflection arm assembly 102. The stage assembly 201 includes the pedestal 203. The pedestal 203 defines a process plane P1. The substrate 107 is disposed on the pedestal 203. The pedestal 203 includes a node 250. The node 250 may be used to calibrate the laser arm assembly 101 and/or the reflection arm assembly 102. In one or more embodiments, the process plane P1 of the pedestal is able to be disposed on an axis A1 of rotation. The ability to make the pedestal 203 co-planar with the axis A1 of rotation enhances the accuracy and precision of the measurement assembly 100. The measurement assembly 100 can use the axis A1 to calibrate the pedestal 203 and ensure the pedestal 203 is flat because the axis A1 is parallel to the base 207. Also, by having the measurement point be consistent along the axis A1, the potential errors can be reduced to deflection of the assemblies 101 102 and pedestal 203 orientation.

By placing the stage assembly 201 between the laser arm assembly 101 and the reflection arm assembly 102, rotations of each arm assembly 101 102 can move independently of the other without the concern of a collision. Further, the configuration of the stage assembly 201 between the laser arm assembly 101 and the reflection arm assembly 102 enables consistency between the assemblies 101 102 reducing the number of factor that would cause variations.

As shown, the laser arm assembly 101 includes a laser motor 219. The laser motor 219 is coupled to the laser arm 105. The laser motor 219 includes a laser motor axis. The laser motor 219 axis is coaxial with the axis A1 of rotation. For example, the axis of the laser motor 219 is about coaxial with the axis A1 of rotation of the laser arm assembly 101.

The laser arm assembly 101 also includes a weight 225 and a base mount 223. The weight 225 is disposed at an end of the laser arm 105, opposite the first optical unit 103. The laser arm 105 is disposed between the first optical unit 103 and the weight 225. The weight 225 is disposed a distance away from the axis A1. The weight 225 is an adjustable the weight. The weight 225 has a mass of about 30 kilograms to about 90 kilogram. The mass of the weight 225 may have a ratio to the mass of the first optical unit 103. For example, the ratio of the mass of the weight 225 to the mass of the first optical unit 103 is about 1:2 to about 1:4, for example, about 1:3 such that the mass of the mass of the weight 225 is about three times the mass of the first optical unit 103. In one or more embodiments, the first optical unit 103 is removable and modular.

The laser arm 105 and first optical unit 103 are configured to be able to deflect less than about 20 microns during operation. The laser arm can rotate at least 180°. For example, the laser arm 105 can rotate +/−80° from a vertical position. In other words the laser arm 105 can rotate in the XZ plane +/−80° from the positive Z direction about the axis A1 of rotation such that the laser arm assembly 101 will deflect less than about 25 microns when rotated.

As shown, the reflection arm assembly 102 includes a reflection motor 220. The reflection motor 220 is coupled to the reflection arm 106. The reflection motor 220 has an axis that is aligned with the axis A1. In other words, the axis of the reflection motor 220 is coaxial with the axis A1 of rotation. The axis of each motor 219, 220 is coaxial with the axis A1 of rotation. In one or more embodiments, the motors 219, 220 are direct drive motors.

The reflection arm assembly 102 also includes a weight (not shown) and a base mount 222. The weight is disposed at an end of the reflection arm 106, opposite the second optical unit 104. The reflection arm 106 is disposed between the second optical unit 104 and the weight. The weight is disposed a distance away from the axis A1. The weight is an adjustable the weight. The weight 225 has a mass of about 30 kilograms to about 90 kilogram. The mass of the weight may have a ratio to the mass of the second optical unit 104. For example, the ratio of the mass of the weight to the mass of the second optical unit 104 is about 1:2 to about 1:4, for example, about 1:3 such that the mass of the mass of the weight is about three times the mass of the first optical unit 103. In one or more embodiments the weight of the laser arm assembly 101 is within about 15% of the weight of the reflection arm assembly 102, to account for variations in components in the optical units 103 104.

In one or more embodiments, the weight 225 of the laser arm assembly 101 and the weight of reflection arm assembly 102 have about the same mass. In one or more embodiments, the weight 225 of the laser arm assembly 101 and the weight of reflection arm assembly 102 have different masses. The measurement assembly 100 includes a base 207. The weight 225 counter balances the weight of the arms 105 and the first optical unit 103. This counter balance puts less strain on the motor 219 so finer adjustability of the measurement assembly 100 can be achieved. The smaller the force requirements, the more precise the movements control. While not shown the reflection arm assembly 102 also includes a weight opposite the second optical unit 104.

In one or more embodiments a first precision gear reducer is included in the laser arm assembly 101 and a second precision gear reducer is included in the reflection arm assembly 102 instead of the weights 225 to account for weight variation in the optical units 103 104.

The stage assembly 201 is disposed on the base 207. The base 207 is a single body. For example, the base 207 is a single granite body. In another example, the base 207 is a single metallic body with a machined surface. The base 207 forms a flat surface with tolerances between about 0.1 microns and 2 microns such that the base has less than 2 microns of variation across a 400×400 millimeter surface of the base 207. The base 207 operates are a reference plane for calibrating the measurement assembly 100. The base mounts 222, 223 of the laser arm assembly 101 and the reflection arm assembly 102 are disposed on the base 207. The base mounts 222, 223 and the motors 219, 220 are similar to ensure the axis of the motors 219, 220 are aligned with the central axis A1.

The stage assembly 201 also includes a movement mechanism 205. The movement mechanism 205 is configured to translate the pedestal 203. The movement mechanism 205 is disposed between the pedestal 203 and the base 207.

The movement mechanism 205 includes a carriage 209 and rail 211. The carriage 209 is disposed between the rail 211 and the pedestal 203. The carriage 209 includes bearing (not shown). The bearings of the carriage 209 are air bearings disposed between the rail 211 and the carriage 209. The air bearings enhance measurement capabilities of the measurement assembly 100 by reducing any unsupported loads a regular ball bearing create. In one or more embodiments, the carriage 209 and pedestal 203 form an air bearing stage assembly. The carriage 209 enables the pedestal to rotate about the X axis, the Y axis, and the Z axis. The carriage 209 can also translate in the X, Y, and Z directions. The carriage 209 can raise and lower the pedestal 203 along the Z axis. The carriage 209 can translate the pedestal 203 in the X and Y direction along the rail 211 and guides 213. The pedestal 203 includes a chuck to hold the substrate 107. In one or more embodiments, the pedestal 203 includes a vacuum chuck. The pedestal 203 is able to translate +/−at least 300 millimeters along the X direction. For example, the pedestal can translate about 350 millimeters or more from the axis A1. The pedestal 203 is able to translate +/−at least 300 millimeters along the Y direction. For example, the pedestal 203 can translate about 320 millimeters or more from a central position on the axis A1. The pedestal 203 is able to translate +/−at least 2 millimeters along the Z direction. For example, the pedestal 203 can translate about 2.5 millimeters or more along the Z direction. The pedestal 203 is able to tilt along the XZ and YZ directions. For example, the pedestal 203 can tilt along the XZ and YZ directions about 0.1° to about 2°.

The guides 213 are disposed on the base 207. The guides 213 are parallel to each other. The laser arm assembly 101, and the reflection arm assembly 102 are disposed between the guides 213. The guides 213 are aligned parallel to the axis of rotation A1. The rail 211 is disposed between the guides 213. The rail 211 is disposed perpendicular to the guides 213. The guides 213 translate the rail 211 parallel to the Y axis. Translating the rail 211 then translates the pedestal 203. The carriage 209 and guides 213 include devices to translate the pedestal 203 in the X direction, parallel to the X axis. By having the rail 211 perpendicular to the guides, the laser arm assembly 101 and the reflection arm assembly 102, can be closer to the pedestal 203. This enhances accuracy and precision of the measurement assembly 100 by reducing the moment created by the overhang of the optical units 103 104. The rail 211 is elevated from the base 207 by the guides 213. This configuration enables the guides 213 to move the rail 211. The carriage 209 and guides 213 are configured such that the pedestal 203 is stationary when power is not flowing to the pedestal 203, carriage 209, and guides 213.

The movement mechanism 205, the laser arm assembly 101, and the reflection arm assembly 102 are configured to dispose the substrate 107 in a position that enables the measurement assembly 100 to perform metrology operations on the optical device 109 with a high degree of accuracy. The laser arm assembly 101 is similar in configuration to the reflection arm assembly 102 in that at least one or more of the corresponding parts of each assembly 101, 102 are about the same. For example, the arms 105,106, the motors 219, 220, and the base mount 222, 223 are about the same size, shape, and material. In one or more embodiments, the parts of the reflection arm assembly 102 and the laser arm assembly 101 are about the same except for the first optical unit 103 and the second optical unit 104.

The base providing a consistent plane of reference for the part of the measurement assembly 100 enables a high level of accuracy and precision. For example, the pedestal 203 is able to have a flatness and straightness of 30 micrometers or less. For example, the pedestal 203 flatness and straightness is accurate to 17 micrometers, or less.

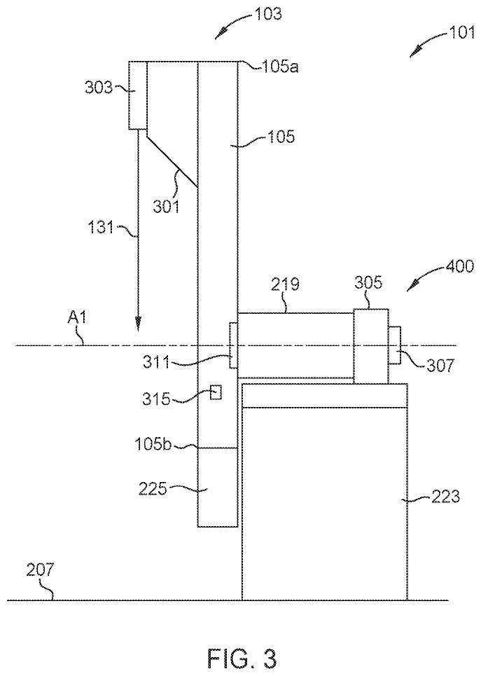

FIG. 3 is a schematic view of the laser arm assembly 101 of the measurement assembly 100 in FIG. 2, according to embodiments described herein.

The laser arm assembly 101 includes a mount assembly 400. The mount assembly 400 includes a motor mount 311, a motor frame 305, a brake 307, and the base mount 223.

The motor mount 311 is coupled to the laser arm 105. The motor mount 311 is also coupled to the laser motor 219 of the laser arm assembly 101. The laser motor 219 is disposed on the motor frame 305. The motor frame 305 holds the laser motor 219 in place. The motor frame 305 is disposed on the base mount 223. The base mount 223 is disposed between the motor frame 305 and the base 207. The base mount 223 raises the motor frame 305 to give the laser arm assembly 101 clearance to rotate and utilize the weight 225.

The laser arm 105 includes the laser end 105a and a second end 105b. The second end 105b is disposed opposite the laser end 105a. The weight 225 is disposed proximate the second end 105b. For example, the weight 225 is coupled to the second end 105b of the laser arm 105 The first optical unit 103 is disposed on the laser end 105a of the laser arm 105. The first optical unit 103 may include a housing 301 and an analysis unit 303. In one or more embodiments, the analysis unit 303 is coupled to the housing 301. In one or more embodiments, the analysis unit 303 is disposed within the housing 301. The analysis unit 303 projects the first beam 131 towards the optical device 109 and/or the substrate 107 (FIG. 1). In one or more embodiments, the first beam is projected towards the axis A1 such that the first beam 131 is perpendicular to the axis A1. In one or more embodiments, the first beam 131 begins in the housing 301 and passes through a lens which focuses the first beam 131 such that the focal point is disposed on a structure 113, a grating 111, an optical device 109, the substrate 107, or other surface for measurement. The first optical unit 103 also includes one or more sensors that receive reflected light. For example, the sensors of the first optical unit 103 receive the second beam 132. The housing 301 of the first optical unit enhances accuracy by proving more rigid support to the components of the first optical unit 103.

The motor mount 311 defines an axis of rotation. The motor mount 311 is disposed in the laser arm 105. The motor mount 311 is disposed between the laser end 105a and the second end 105b. The motor mount is disposed closer to the second end 105b then the laser end 105a. For example the motor mount 311 is disposed proximate and/or adjacent to the second end 105b.

The motor mount 311 is aligned with the axis A1. The configuration described above is configured so that the axis A1 is parallel to the base 207. The relation to the axis A1 and the base enhances accuracy by providing consistent geometries to reference during calibration and measurement operations.

The laser arm 105 also includes one or more alignment features 315. In one or more embodiments the alignment features 315 are one or more lasers that align the arms 105, 106. In one or more embodiments the alignment features 315 are on or more alignment pins disposed on the one or more sides of the laser arm 105. In one or more embodiments the alignment features 315 are one or more apertures disposed on one or more sides of the laser arm 105. The one or more alignment features 315 are also on the reflection arm 106 of the reflection arm assembly 102 (FIG. 2). The alignment features 315 enable calibration of both the reflection arm assembly 102 and the laser arm assembly 101.

The brake 307 is coupled to the laser motor 219 and the motor frame 305. In one or more embodiments, the brake 307 is disposed on the motor frame 305 opposite of the laser arm 105. In other words, the laser motor 219 is disposed between the laser arm 105 and the brake 307.

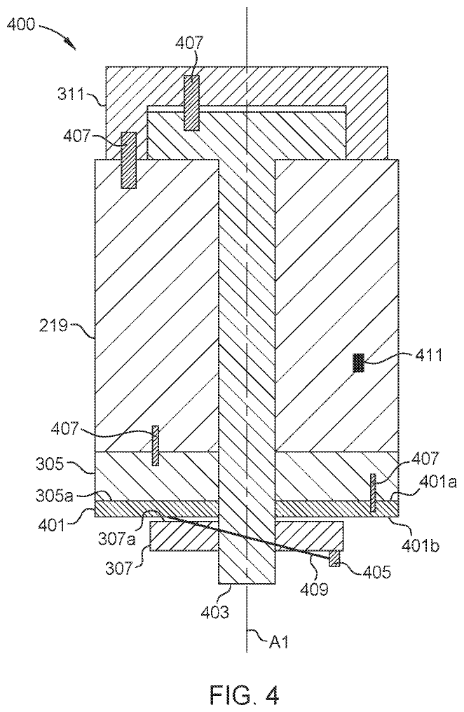

FIG. 4 is a schematic sectional view of the mount assembly 400, according to embodiments described herein.

While previously discussed in the context of the laser arm assembly 101, one or more of the described embodiments may be applied to the reflection arm assembly 102 (FIGS. 1 and 2) as well. In one or more embodiments, the motor mount 311 is coupled to a shaft 403. The motor mount 311 is coupled to a shaft 403 by one or more pieces of hardware 407. The hardware 407 may be, but not limited to, a bolt, a screw, a pin, or any other hardware meant to affix two or more bodies together. The shaft 403 is aligned with the axis A1. The shaft 403 extends through the laser motor 219 along the axis A1. The laser motor 219 is configured to rotate the shaft 403 and rotate the motor mount 311.

In one or more embodiments, the laser motor 219 is coupled to the motor frame 305. The laser motor 219 is coupled to the motor frame 305 by one or more pieces of hardware 407. The laser motor 219 is configured to rotate the shaft 403 and rotate the motor mount 311 such that the motor mount 311 receives the rotation from the shaft 403.

The mount assembly 400 includes the brake 307 and brake plate 401. The motor frame 305 is disposed between the brake 307 and brake plate 401. The brake 307 is coupled to the shaft 403. In one or more embodiments, the brake 307 includes a spring 409. The brake 307 and brake plate 401 are coupled by the spring 409. In one or more embodiments, the brake 307 includes an actuator 405. In one or more embodiments, the brake 307 is a spring brake and the actuator 405 is a normally closed solenoid. For example, the brake is a spring break coupled to a normally closed solenoid. The brake plate 401 is disposed on an outer face 305a of the motor frame 305. For example, an inner face 401a of the brake plate 401 is coupled to the outer face 305a of the motor frame 305 by hardware 407.

In one or more embodiments, the actuator 405 is a solenoid that releases tension on the spring 409 when the actuator 405 receives an electromagnetic signal. For example, when there is not a signal to the actuator 405, the spring 409 forces an inner face 307a to contact the outer face 401b of the brake plate 401, preventing movement of the brake 307 and shaft 403. When the actuator 405 is receiving a signal, the shaft 403 can rotate. The controller 160 (FIG. 1) controls when the brake 307 is engaged by communication with the actuator 405. The controller 160 controls the laser arm assembly 101 by a closed loop control and the brake 307 operates as a safety mechanism to lock the laser motor 219 in place if the controller 160 loses power and/or receives an error alert. In one or more embodiments, the laser motor 219 alternatively controls the actuator 405. In one or more embodiments the brake 307 and the actuator 405 form a spring brake coupled to a normally closed solenoid.

The motors 220,219 include one or more encoders 411. The encoder 411 is of each motor is configured to measure a rotation of the laser arm assembly 101 and or the reflection arm assembly 102. The encoder 411 provides the angular location of the laser arm assembly 101. The encoder 411 is enables measured movements of the laser arm and reflection arm to have an angular accuracy and/or repeatability accurate to about 30 micro radians or less. For example, the encoder 411 is accurate to 17 micro radians. This enhances the precision of the measurement assembly 100. In one or more embodiments, the encoder 411 is an optical encoder that directly reads the angular position of the arm itself. By using an optical encoder the positioning does not affect the arm position, leading to enhanced accuracy.

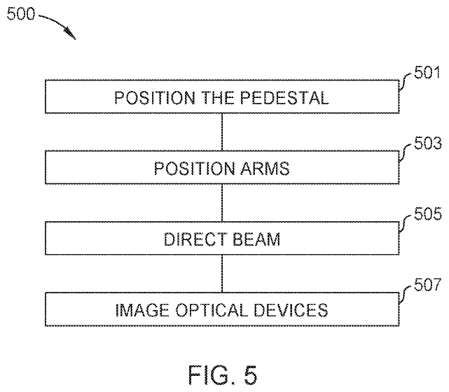

FIG. 5 is a flow diagram of a method of optical device metrology according to embodiments described herein. The CPU 160a of the controller 160 is configured to execute the method 500. The method 500 is a measurement operation stored on the memory 160b of the controller 160.

At operation 501, the substrate 107 (FIG. 1) is moved to a first position. The first position disposes the pedestal 203 (FIG. 2) such that a structure 113, or a grating 111 of the optical device 109 is ready for a metrology operation. The pedestal 203 may rotate around the X axis, Y axis and/or Z axis to orient the substrate 107 so that a grating 111 of the optical device 109 can be in the path of the first beam 131. The pedestal 203 may translate the substrate parallel to the X axis, Y axis and/or Z axis to orient the substrate 107 so that a grating 111 of the optical device 109 can be in the path of the first beam 131.

At operation 503, the laser arm assembly 101 is rotated to align the first optical unit 103 about perpendicular to an orientation angle of a grating 111 on a substrate and the reflection arm assembly 102 is rotated to align the second optical unit 104 to about parallel with the orientation angle of the first optical device.

At operation 505, the measurement assembly performs an optical measurement on the first optical device. The optical measurement includes projecting the first beam 131 is directed from the first optical unit 103 towards the substrate 107 and/or a grating 111 of the optical device 109. The second beam 132 is reflected from the grating 111 to the first optical unit 103. The third beam 141 is reflected from the grating 111 towards the second optical unit 104.

At operation 507, sensors within the first optical unit 103 and second optical unit 104 image the first optical device. Operations 501, 503, and 505 are repeated until the optical device 109 is imaged and one or more of a grating 111 pitch, orientation, duty cycle, and reflectivity are determined.

A benefit of the disclosure includes the ability to hold the laser arm assembly 101 and the reflection arm assembly 102 in place by the brake 307, in the event of a power failure or if there is an unsafe condition. For example, if the enclosure 150 (FIG. 1) is opened during an operation. Another benefit is the ability to use the base 207 and the axis A1 as a reference for calibrating the pedestal 203 which enhances accuracy because all components can be referenced off a single plane. Another benefit is the ability of the pedestal 203 to translate along and around the X axis, Y axis, and Z axis which is enabled by the configuration of the guides 213 and rail 211. The similarities in the assemblies 101 102 ensure the movements are consistent and repeatable. Specifically, as the assemblies 101 102 are disposed closer to a horizontal position, the assemblies 101 102 experience about uniform deflection characteristics. Thus, the assemblies 101 102 will have uniform errors instead of errors relative to each specific assembly 101 102. By having uniform errors caused by uniform deflection, a root cause analysis to find the source of the error and the subsequent correction is expedited.

It is contemplated that one or more aspects disclosed herein may be combined. As an example, one or more aspects, features, components, operations and/or properties of the measurement assembly 100, the laser arm assembly 101, reflection arm assembly 102, pedestal 203, the rail 211, guides 213, the weights 225, the base 207 shown in FIG. 2, the brake 307, the first optical unit 103 shown in FIG. 3, the actuator 405, the encoder 411, the spring 409 shown in FIG. 4 and the method 500, maybe be combined. Moreover, it is contemplated that one or more aspects disclosed herein may include some or all of the aforementioned benefits.

While the foregoing is directed to embodiments of the present disclosure, other and further embodiments of the disclosure may be devised without departing from the basic scope thereof, and the scope thereof is determined by the claims that follow.

What is claimed is:

1. A laser arm assembly comprising:
a laser arm, the laser arm comprising:
a motor mount disposed between a laser end of the laser arm and a second end of the laser arm, the motor mount defining an axis of rotation;
an optical unit coupled to the laser end of the arm, the optical unit comprising a light source, directed towards the axis of rotation;
a weight disposed on the second end of the arm; and
a motor coupled to the motor mount of the arm, the motor comprising:
a brake;
a laser motor axis coaxial with the axis of rotation; and
an encoder.

2. The laser arm assembly of claim 1, further comprising an alignment pin disposed on a side of the laser arm.

3. The laser arm assembly of claim 1, wherein the motor is a direct drive motor coupled to the encoder, the encoder is configured to measure a rotation of the laser arm assembly.

4. The laser arm assembly of claim 1, wherein the optical unit further comprises:
a multi axis position module coupled to an aperture; and
a sensor.

5. The laser arm assembly of claim 1, wherein the brake is a spring brake coupled to a normally closed solenoid.

6. A measurement assembly comprising:
a laser arm assembly, the laser arm assembly comprising:
a laser arm;
a laser motor defining an axis of rotation; and
a first optical unit disposed on a laser end of the laser arm;
a reflection arm assembly, the reflection arm assembly comprising:
a reflection arm;
a reflection motor, the reflection motor comprising a motor axis coaxial with the axis of rotation of the laser arm; and
a second optical unit disposed on a first end of the reflection arm; and
a stage assembly disposed between the laser arm assembly and the reflection arm assembly, the stage assembly comprising:
a pedestal, the pedestal defining a process plane; and
a movement mechanism, configured to translate the stage assembly.

7. The measurement assembly of claim 6, further comprising a base, the laser arm assembly, the reflection arm assembly, and the stage assembly disposed on the base.

8. The measurement assembly of claim 6, wherein a measuring point of the first optical unit is the same as the measuring point of the second optical unit.

9. The measurement assembly of claim 6, further comprising a base with a rail, the rail being disposed about perpendicular to the axis of rotation.

10. The measurement assembly of claim 9, wherein the stage assembly is an air bearing stage assembly.

11. The measurement assembly of claim 6, further comprising an enclosure disposed around the measurement assembly, the enclosure comprising an atmospheric control unit.

12. The measurement assembly of claim 6, wherein the movement mechanism is configured such that the stage assembly can translate the pedestal parallel to an X axis, a Y axis, a Z axis, and rotate the pedestal about the X axis, the Y axis, and the Z axis.

13. The measurement assembly of claim 6, wherein movements of the laser arm, the reflection arm, and the stage assembly have a repeatability with an angular accuracy of 30 micro radians or less and the pedestal has a flatness of 20 micrometers or less.

14. The measurement assembly of claim 6, wherein the laser arm and the reflection arm are about the same.

15. The measurement assembly of claim 6, wherein the pedestal further comprises a vacuum chuck.

16. The measurement assembly of claim 6, wherein the first optical unit is removable.

17. A measurement assembly comprising:
a laser arm assembly comprising:
a laser arm having a laser end;
a laser motor, the laser motor defining an axis of rotation; and
a first optical unit disposed on the laser end of the laser arm;
a reflection arm assembly comprising:
a reflection arm having a first end;
a reflection motor comprising a motor axis, the motor axis coaxial with the axis of rotation of the laser arm assembly; and
a second optical unit disposed on the first end of the reflection arm;
a stage assembly disposed between the laser arm assembly and the reflection arm assembly, the stage assembly comprising:
a pedestal, the pedestal defining a process plane; and
a movement mechanism, the movement mechanism configured to enable the process plane to be co-planar with the axis of rotation;
a controller for controlling the measurement assembly; and
a non-transitory computer readable medium having instructions stored thereon which, when executed by a processor, causes the process to perform a measurement method, the method comprising:
moving a substrate to a first position;
rotating the laser arm assembly to align the first optical unit about perpendicular to an orientation angle of a grating on the substrate;
rotating the reflection arm assembly to align the second optical unit to about parallel with the orientation angle of the grating; and
performing a optical measurement on the grating.

18. The measurement assembly of claim 17, wherein the method further comprises:
moving the pedestal to a second position;
rotating the laser arm assembly to align the first optical unit about perpendicular to a second orientation angle of a second optical device on the substrate;
rotating the reflection arm assembly to align the second optical unit to about parallel with the second orientation angle of the second optical device; and
performing a measurement on the second optical device.

19. The measurement assembly of claim 17, wherein moving the pedestal includes at least one of rotating the pedestal about an X axis, a Y axis, or a Z axis, and translating the pedestal along the X axis, the Y axis, or the Z axis. The measurement assembly of claim 17, wherein the method further comprises:
calibrating the measurement assembly by aligning the first optical unit with a node disposed on the pedestal.
